(19) United States
(12) Patent Application Publication
(10) Pub. No.: US 2024/0337562 A1
(43) Pub. Date: Oct. 10, 2024

(54) MONITORING SYSTEM

(71) Applicant: THK CO., LTD., Tokyo (JP)

(72) Inventor: Masatomo Tokuno, Tokyo (JP)

(73) Assignee: THK CO., LTD., Tokyo (JP)

(21) Appl. No.: 18/708,670

(22) PCT Filed: Nov. 8, 2022
(86) PCT No.: PCT/JP2022/041497

§ 371 Date: May 9, 2024

(30) Foreign Application Priority Data
Nov. 12, 2021 (JP) 2021-185056

(51) Int. Cl. G01M 13/028; G01H 17/00

(52) U.S. Cl. CPC G01M 13/028; G01H 17/00

(57) ABSTRACT

Provided is a monitoring system that enables to check a state of a movable part even without the need for a user to move to a place of a motion guiding device and to specify time when damage and/or the like occurred. A monitoring system (1) according to an aspect of this invention is a monitoring system that monitors a degree of at least one of damage and lubrication in a given movable part of one or more motion guiding devices (3), the monitoring system including: a storage section (13) that accumulates therein information corresponding to a sensing result obtained by a sensor (5) provided to the motion guiding device (3); and a control section (12) that outputs information indicative of the degree corresponding to the sensing result for the motion guiding device (3) which is designated by user's input.

### TECHNICAL FIELD

The present invention relates to a monitoring system that monitors a motion guiding device.

### BACKGROUND ART

There has been known a conventional diagnosis device that (i) senses vibrations occurring when a given movable part of a motion guiding device (e.g., a ball screw device) moves and (ii) diagnoses, e.g., a degree of damage in the movable part. Non-Patent Literature 1 discloses a vibration diagnostic device capable of measuring and diagnosing a state of a rotating machine on site.

### CITATION LIST

### Non-Patent Literature

[Non-Patent Literature 1]

“Waiyaresu shindou shindanki Bearing Doctor BD-2 kata no goshoukai” (Introduction of wireless vibration diagnostic device Bearing Doctor BD-2), [online], NSK LTD., [searched on Oct. 13, 2021], Internet <URL: https://www.acousnavi.nsk.com/jp/bearing-bd2/>

### SUMMARY OF INVENTION

### Technical Problem

However, the conventional technique such as the above-discussed one requires a user to move the diagnosis device to a place of the motion guiding device for each diagnosis, and thus takes time and effort. Furthermore, with such a conventional technique, it is difficult to identify time when damage and/or the like occurred in the movable part.

An aspect of the present invention was made in consideration of the above problems, and has an object to provide a monitoring system that enables to check a state of a movable part even without the need for a user to move to a place of a motion guiding device and to specify time when damage and/or the like occurred.

### Solution to Problem

In order to attain the above object, a monitoring system in accordance with a first aspect of the present invention is a monitoring system that monitors a degree of at least one of damage and lubrication in a given movable part of one or more motion guiding devices, the monitoring system including: a storage section that accumulates therein information corresponding to a sensing result obtained by a sensor provided to the one or more motion guiding devices; and a control section that outputs information indicative of the degree corresponding to the sensing result with respect to one of the one or more motion guiding devices which is designated by input from a user.

According to the above configuration, the user can check, via a terminal device, past information relating to damage or the like which information is accumulated in the storage section, for example. Thus, it is possible to provide a monitoring system that enables to check a state of a movable part even without the need for a user to move to a place of a motion guiding device and to specify time when damage and/or the like occurred.

A monitoring system in accordance with a second aspect of the present disclosure is configured such that, in the first aspect, the control section predicts, with reference to the information corresponding to the sensing result, time when the degree of at least one of damage and lubrication in the movable part reaches a predetermined degree.

The above configuration contributes to, for example, preparation of a plan of carrying out, e.g., exchange or maintenance of the movable part.

A monitoring system in accordance with a third aspect of the present disclosure is configured such that, in the second aspect, the monitoring system further includes: a learning section that trains a learning model with use of training data, the learning model receiving input of the information corresponding to the sensing result and outputting the predicted time when the degree of at least one of damage and lubrication in the movable part reaches the predetermined degree, the training data being a set of information corresponding to a sensing result obtained by the sensor and time when a degree of at least one of damage and lubrication in the movable part has reached the predetermined degree.

The above configuration, in which the control section uses the learning model, contributes to enhancement in accuracy for predicting the time when the degree reaches the predetermined degree.

A monitoring system in accordance with a fourth aspect of the present disclosure is configured such that, in any one of the first to third aspects, the storage section is included in a server device on a cloud; and in response to designation of at least one of the one or more motion guiding devices, the control section obtains, from the server device, information corresponding to the sensing result with respect to the designated one of the one or more motion guiding devices.

According to the above configuration, the information with respect to the motion guiding device is obtained and output in response to designation of that information. Thus, it is possible to reduce communication traffic from the server with respect to the terminal device used by the user to check the information.

A monitoring system in accordance with a fifth aspect of the present disclosure is configured such that, in any one of the first to fourth aspects, in a case where a value indicative of the information corresponding to the sensing result in at least one of the one or more motion guiding devices satisfies a predetermined condition, the control section notifies information indicating that the predetermined condition is satisfied.

The above configuration contributes to enabling a user to quickly acknowledge that the predetermined condition is satisfied.

A monitoring system in accordance with a sixth of the present disclosure is configured such that, in any one of the first to fifth aspects, the monitoring system further includes: an amplifier associated with the sensor, the amplifier supplying information indicative of a feature extracted from the sensing result to the storage section as the information corresponding to the sensing result.

According to the above configuration, it is possible to reduce an amount of data of information to be stored in the storage section.

A monitoring system in accordance with each aspect of the present invention can be realized by a computer. In this case, the present invention encompasses: a control program for causing a computer to function as each of the sections (software elements) included in the monitoring system so as to realize the monitoring system by the computer; and a computer-readable storage medium having the control program stored therein.

### Advantageous Effects of Invention

In accordance with an aspect of the present invention, it is possible to provide a monitoring system that enables to check a state of a movable part even without the need for a user to move to a place of a motion guiding device and to specify time when damage and/or the like occurred.

### BRIEF DESCRIPTION OF DRAWINGS

FIG. 1 is a functional block diagram illustrating an example of a configuration of an overall system including a monitoring system.

FIG. 2 illustrates an example of a linear guide device and an example of a ball screw device.

FIG. 3 shows cross-sectional views of the ball screw device and the linear guide device.

FIG. 4 shows examples of signal levels relating to damage and lubrication in the linear guide device.

FIG. 5 shows an example of a flowchart illustrating a flow of a process carried out in a monitoring system.

FIG. 6 shows an example of a display screen to be generated by a control section and to be displayed by a terminal device.

FIG. 7 shows an example of the display screen to be generated by the control section and to be displayed by the terminal device.

FIG. 8 shows an example of the display screen to be generated by the control section and to be displayed by the terminal device.

FIG. 9 shows an example of the display screen to be generated by the control section and to be displayed by the terminal device.

### DESCRIPTION OF EMBODIMENTS

The following description will discuss details of an embodiment of the present invention.

### Example of Overall Configuration

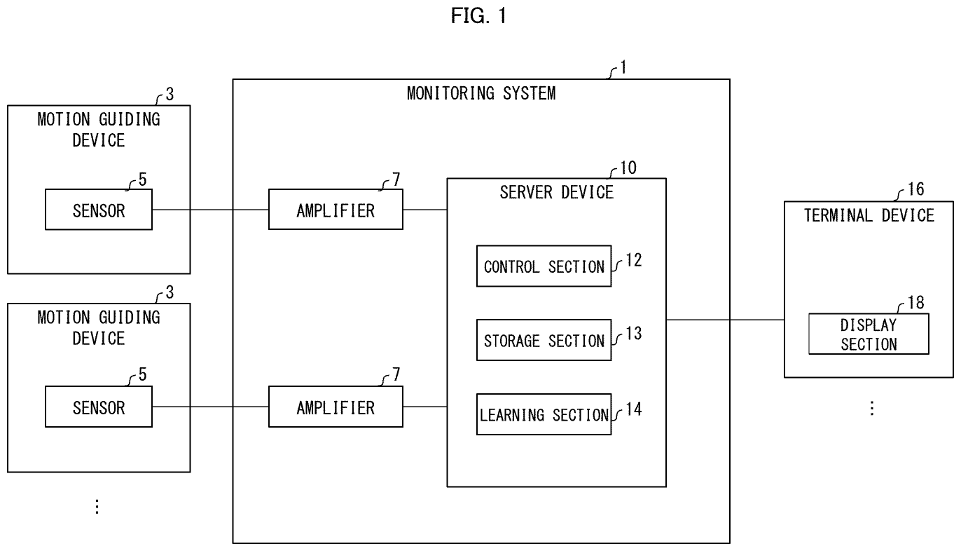

FIG. 1 is a functional block diagram illustrating an example of a configuration of an overall system including a monitoring system 1. The following will describe each of devices included in the system shown in FIG. 1.

A motion guiding device 3 is a device including a given movable part that moves over a rail or a screw shaft. For example, the motion guiding device 3 is a ball screw device, a linear guide device, or an actuator device. The motion guiding device 3 is provided with a sensor 5 that senses vibrations occurring when the movable part moves.

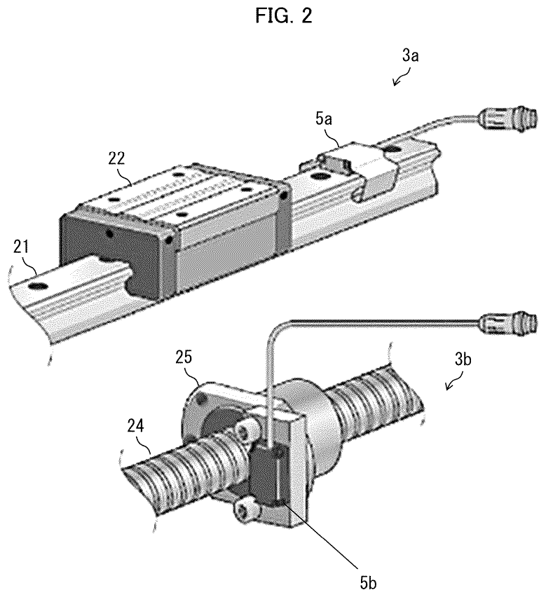

FIG. 2 illustrates an example of the linear guide device and an example of the ball screw device. For a linear guide device 3a in the example shown in FIG. 2, a clamp-type sensor 5a is attached to a rail 21. In the linear guide device, a guide block 22 corresponds to the above-discussed given movable part. Further, for a ball screw device 3b in the example shown in FIG. 2, a co-fastened type sensor 5b, which is configured to be fixed with a screw, is attached to a nut 25, which is a given movable part that moves over a screw shaft 24. The sensors 5 output, as voltage waveforms, sensed vibrations to amplifiers 7 connected to the sensors 5 by wires, respectively. Alternatively, the sensors 5 and the amplifiers 7 may be wirelessly connected to each other.

The method for attaching the sensor 5 to the motion guiding device 3 may be, for example, an adhering type according to which the sensor 5 is fixed to the rail by adhesion, instead of the clamping type for sandwiching the rail or the co-fastening type for fixing with a screw.

The monitoring system 1 includes one or more amplifiers 7 and a server device 10. The amplifier 7 extracts, from a voltage waveform indicative of a sensing result of the sensor 5, information indicative of a feature, and outputs the extracted information indicative of the feature to the server device 10 as information corresponding to the sensing result. The information output to the server device 10 is supplied to a storage section 13. Note that a single amplifier 7 may be configured to receive sensing results of a plurality of sensors 5 provided to one or more motion guiding devices 3.

The server device 10 is a device that accumulates therein information having been input from the amplifier 7 and that functions as a server for a terminal device 16. The server device 10 includes a control section 12, the storage section 13, and a learning section 14.

The control section 12 is a device, such as a CPU, that comprehensively controls the entire server device 10. For example, the control section 12 outputs information indicative of a degree of at least one of damage and lubrication in a given movable part of a motion guiding device 3. Each of the degree of damage and the degree of lubrication corresponds to a sensing result with respect to a motion guiding device 3 designated by a user, and is calculated by the control section 12. Further, the control section 12 carries out, for example, control relating to a communication process with the amplifier 7 and the terminal device 16.

The storage section 13 is a storage device that stores therein various kinds of information. For example, the storage section 13 stores therein information corresponding to a sensing result which information has been input from the amplifier 7. Further, the storage section 13 stores therein a parameter set that defines a learning model to be used by the learning section 14.

The learning section 14 trains a learning model that receives input of a sensing result obtained by the sensor 5 and predicts time when a degree of at least one of damage and lubrication in the movable part reaches a predetermined degree. Note that the degree of lubrication gradually decreases, and the decrease in the degree of lubrication means an increase in a degree of exhaustion of lubrication.

In training of the learning model, a set of a sensing result obtained by the sensor 5 and time when the degree has reached the predetermined degree is used as training data, and the parameter set stored in the storage section 13 is updated. Note that the control section 12 may function also as the learning section 14.

The terminal device 16 is a device that functions as a client with respect to the server device 10. For example, the terminal device 16 is a personal computer, a smartphone, a tablet terminal, or the like. According to input from a user, the terminal device 16 causes a display section 18 to display information obtained from the server.

Note that the system shown in FIG. 1 may be configured as follows. That is, the motion guiding device 3 and the terminal device 16 may be included in the monitoring system 1, and the amplifier 7 may not be included in the monitoring system 1. Further, each of the number of server devices 10 and the number of terminal devices 16 is not limited to one, and may be two or more.

Some of or all of the sections included in the server device 10 may be provided, according to an on-premises style, in the same facility as the motion guiding device 3 and the amplifier 7. Alternatively, some of or all of the sections included in the server device 10 may be provided, according to a cloud style, in a data center or the like in a remote area.

That is, according to an aspect, the storage section 13 may be included in the server device 10 on a cloud and, in response to designation of at least one of the one or more motion guiding devices 3, the control section 12 may obtain, from the storage section 13 of the server device 10, information corresponding to a sensing result with respect to the designated motion guiding device 3.

In a case where the server device 10 and the amplifier 7 are provided in the same facility, the amplifier 7 may transmit information to the server device 10 with use of a dongle or the like.

### Example of Damage in Movable Part

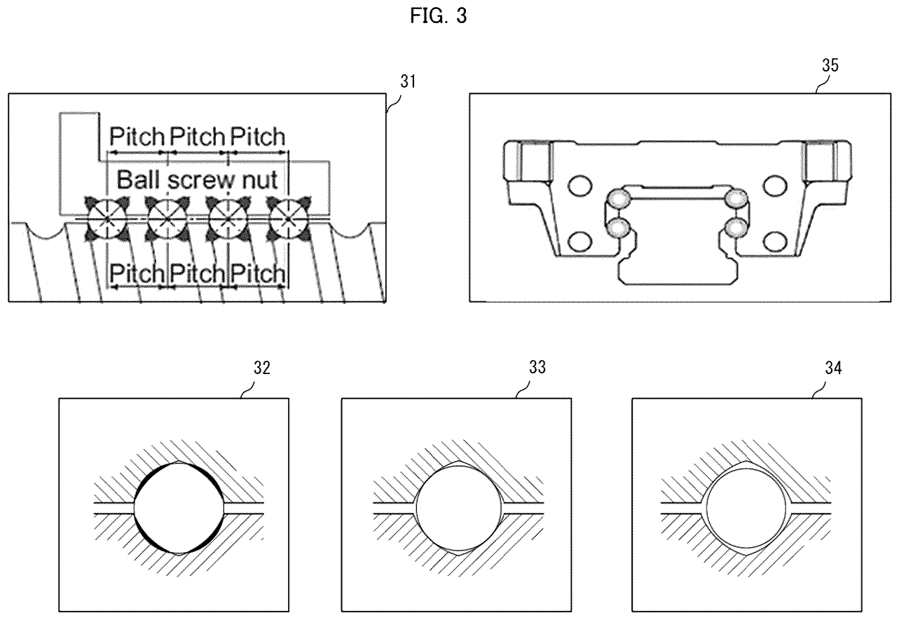

Next, the following will describe a preload loss in the motion guiding device 3 as an example of damage in the given movable part of the motion guiding device 3. FIG. 3 shows cross-sectional views of the ball screw device and the linear guide device.

An explanatory diagram 31 in FIG. 3 illustrates a state where a ball of a ball screw is sandwiched between equally-spaced grooves on a surface of a screw shaft and grooves inside a nut. While the nut is moving over the screw shaft, the ball circulates inside the nut in a state where the ball is in contact with a surface of the grooves.

An explanatory diagram 32 illustrates the ball which is in a preloaded state. In the preloaded state, pressure from the surface of the grooves is applied to the ball. An explanatory diagram 33 illustrates the ball which has no gap with respect to the surface of the grooves. An explanatory diagram 34 illustrates the ball which has a gap with respect to the surface of the grooves. In the states of the explanatory diagrams 33 and 34, no pressure from the surface of the grooves is applied to the ball.

As a result of long-term use of the ball screw device, wearing or flaking gradually occurs in a surface of the ball. Consequently, the ball in the state of the explanatory diagram 32 loses its preload, so as to be brought into the state of the explanatory diagram 33 and then into the state of the explanatory diagram 34.

In the state of the explanatory diagram 34, backlash occurs between the nut and the screw shaft, which causes a phenomenon such as reduction in rigidity, poor machining surface, dimensional precision deviation, or increase of lost motion.

Also when wearing or flaking occurs in the ball in the guide block as a result of long-term use of the linear guide device shown in the explanatory diagram 35, backlash occurs similarly. Furthermore, wearing or flaking occurs also in the screw shaft and the nut of the ball screw device as well as the rail and the guide block of the linear guide device, although the degree thereof is smaller than that of the ball. This may cause thus occurred changes vibrations backlash. Backlash occurring when the nut, which is the movable part, moves over the screw shaft.

### Example of Diagnosis of Damage and Lubrication

Next, the following will describe change in signal levels in the linear guide device as examples of diagnostic results of damage and lubrication in the given movable part of the motion guiding device 3. Each signal level is an index value corresponding to vibrations occurring when the given movable part of the motion guiding device 3 moves. The index value is calculated by the amplifier 7 applying a given algorithm to an input value.

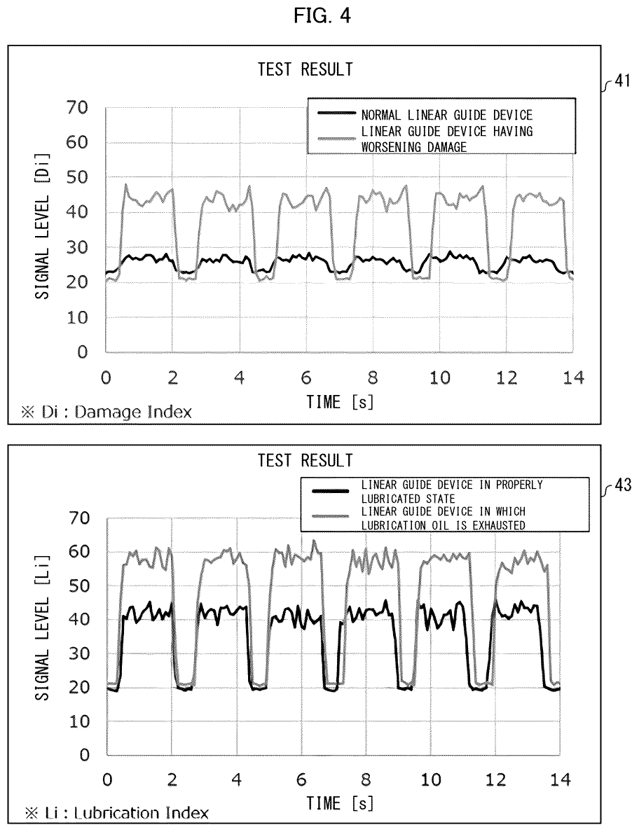

FIG. 4 shows examples of signal levels relating to damage and lubrication in the linear guide device. Here, an explanatory diagram 41 in FIG. 4 shows an example of signal levels relating to damage, the signal levels being observed in a normal linear guide device having no damage and a linear guide device having damage. An explanatory diagram 43 shows examples of signal levels relating to lubrication, the signal levels being observed in a linear guide device whose degree of lubrication is appropriate and a linear guide device in which lubrication oil is exhausted. The horizontal axes in the explanatory diagrams 41 and 43 each indicate time. The vertical axis in the explanatory diagram 41 indicates a signal level relating to damage, whereas the vertical axis in the explanatory diagram 43 indicates a signal level relating to lubrication.

As shown in the explanatory diagrams 41 and 43, in a case where the degree of damage or the degree of lubrication is abnormal, signal levels are higher than those observed in a normal state. Further, in each of the explanatory diagrams 41 and 43, six mountain-like portions where values constituting a graph of the signal level are high correspond to three round trips of the guide block over the rail. That is, each of the mountain-like portions corresponds to one stroke of the guide block in a forward path or a return path over the rail.

In a case where the degree of damage or the degree of lubrication in the guide block portion including the ball is abnormal, an influence caused thereby is exerted while the guide block is moving, regardless of the location of the guide block. Thus, in the above case, the signal level observed while the guide block is moving is always high, as illustrated in the explanatory diagrams 41 and 43. Meanwhile, in a case where the degree of damage or the degree of lubrication in an area where the rail portion is present is abnormal, an influence caused thereby is exerted while the guide block is passing through the above area, whereby the signal level becomes high.

Further, the amplifier 7 may extract, e.g., information indicative of features relating to a height and a waveform of the above-described signal level, and may output the information indicative of the features to the server device 10 as the information corresponding to the sensing result of the sensor 5. Consequently, it is possible to reduce an amount of data to be transmitted from the amplifier 7 to the server device 10.

By referring to the information corresponding to the sensing result which information is input from the amplifier 7, the control section 12 of the server device 10 calculates the degree of damage or the degree of lubrication in, e.g., the movable part of the motion guiding device 3.

Further, with reference to the information input from the amplifier 7, the control section 12 may predict time when the degree of at least one of damage and lubrication in, e.g., the movable part reaches the predetermined degree. The control section 12 may predict the above time by referring to a plurality of pieces of information input from the amplifier 7 at different timings or by use of any of various kinds of machine learning methods.

For example, the control section 12 may predict the above time with use of a learning model that receives input of the information corresponding to the sensing result and outputs predicted time when the degree of at least one of damage and lubrication in, e.g., the movable part reaches the predetermined degree. The learning model is trained by the learning section 14 with use of training data which is a set of information corresponding to a sensing result and time when the degree has reached the predetermined degree.

### Flow of Process Carried out in Monitoring System 1

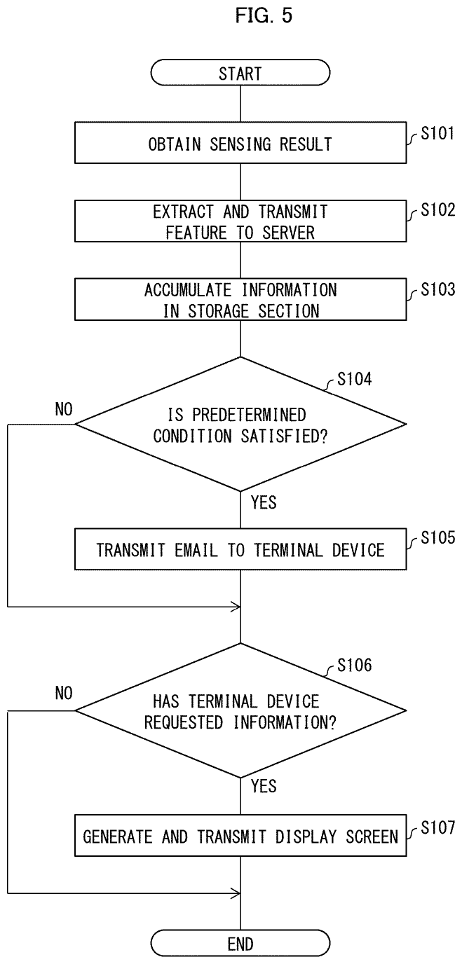

Next, the following will describe a flow of a process carried out in the monitoring system 1. FIG. 5 shows an example of a flowchart illustrating the flow of the process carried out in the monitoring system 1. The process illustrated in the flowchart in FIG. 5 is executed repeatedly after the motion guiding devices 3 and the monitoring system 1 are activated.

In S101 (step S101), from the sensors 5, the amplifier(s) 7 obtains, as voltage waveforms, sensing results of the sensors 5 obtained when the given movable parts of the motion guiding devices 3 moves.

In S102, the amplifier 7 extracts, from the sensing results of the sensors 5, information indicative of features. Specifically, the amplifier 7 applies a given algorithm to the voltage waveforms indicative of the sensing results of the sensors 5, so as to extract information indicative of features from the voltage waveforms. Alternatively, the amplifier 7 may calculate the signal levels illustrated in FIG. 4 on the basis of the voltage waveforms, and may extract information indicative of features relating to heights and waveforms of the signal levels. Subsequently, the amplifier 7 outputs the information indicative of the extracted features to the server device 10 as the information corresponding to the sensing results of the sensors 5.

In S103, the control section 12 of the server device 10 accumulates, in the storage section 13, the information corresponding to the sensing results which information is input from the amplifier 7.

In S104, with reference to the information corresponding to the sensing results, the control section 12 determines whether or not a degree of at least one of damage and lubrication in the given movable part of each of the motion guiding devices 3 satisfies a predetermined condition. The predetermined condition is a condition for indicating that the degree of damage or the degree of lubrication is abnormal or a condition for indicating that the degree of damage or the degree of lubrication is predicted to become abnormal, examples of which include a condition that is satisfied when the signal level illustrated in FIG. 4 becomes not less than a reference value.

If the control section 12 determines that the predetermined condition is satisfied (S104: YES), the control section 12 notifies, in S105, the terminal device 16 about information indicating that the predetermined condition is satisfied. The determination in S104 is made for each of the sensing results with respect to the respective motion guiding devices 3. That is, if a value indicative of information corresponding to a sensing result in at least one of the one or more motion guiding devices 3 satisfies the predetermined condition, the control section 12 notifies the terminal device 16 about information indicating that the predetermined condition is satisfied. There is no particular limitation on a method for giving the notification to the terminal device 16. For example, the notification may be given to the terminal device 16 by transmission of an email or by push notification. Meanwhile, if the control section 12 determines that the predetermined condition is not satisfied (S104: NO), then the control section 12 executes a process in S106.

In S106, the control section 12 determines whether or not the terminal device 16 has requested transmission of the information corresponding to the sensing result with respect to one of the motion guiding devices 3 which information is indicative of the degree of damage or the degree of lubrication. If the control section 12 determines that the terminal device 16 has requested transmission of the information indicative of the degree of damage or the degree of lubrication (S106: YES), the control section 12 generates a display screen including the information and transmits the generated display screen to the terminal device 16 in S107. From a different point of view, in response to user input, the terminal device 16 obtains, from the server device 10, the display screen with respect to the designated motion guiding device 3 and causes the display section 18 to display the display screen thus obtained. Examples of various display screens generated by the control section 12 will be described later. Alternatively, the terminal device 16 may generate the display screen on the basis of the information obtained from the server device 10.

If the control section 12 determines, in S106, that the terminal device 16 has not requested transmission of the information indicative of the degree of damage or the degree of lubrication (S106: NO), the process illustrated in the flowchart in FIG. 5 is ended.

As described above, the process illustrated in the flowchart in FIG. 5 is executed repeatedly. However, each of the processes in S101 to S105 is not limited to this. Alternatively, after the motion guiding devices 3 and the monitoring system 1 are activated, each of the processes in S101 to S105 may be executed only predetermined number of times at predetermined timings, for example.

### Example of Display Screen

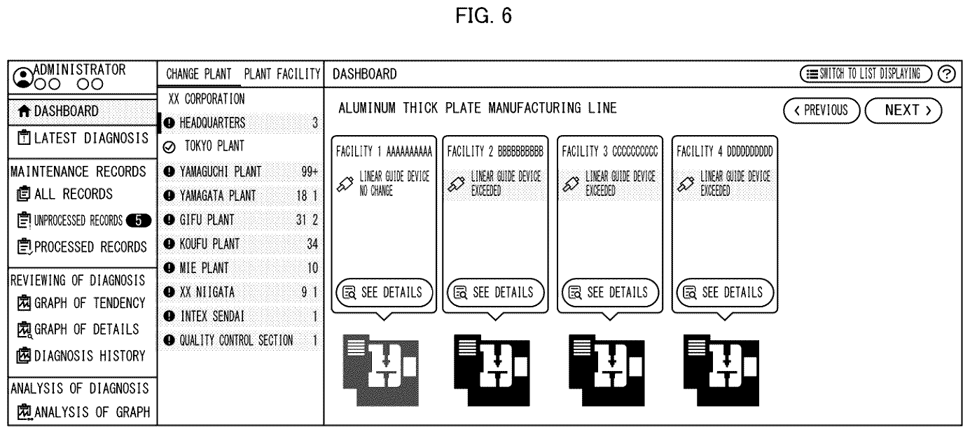

Next, the following will describe an example of the display screen to be generated by the control section 12 and to be displayed by the terminal device 16. Each of FIGS. 6 to 9 illustrates an example of the display screen. In response to selection of an object on each of the screens shown in FIGS. 6 to 9, an item corresponding to the selection is displayed.

In the example shown in FIG. 6, any of the plants or the like can be selected to review information relating to a motion guiding device 3 provided in the respective plant. Further, in FIG. 6, information relating to a linear guide device in an “aluminum thick plate manufacturing line” in “Tokyo plant” is caused to be displayed. Here, “no change” in the “dashboard” indicates a state where a degree of damage and a degree of lubrication in a given movable part or the like of a respective motion guiding device 3 are normal. Meanwhile, “exceeded” therein indicates a state where the degree of damage or the degree of lubrication is abnormal.

The item “latest diagnosis” in the left row is an item used to retrieve the latest determination result indicative of whether or not the degree of damage or the degree of lubrication is normal. The item “all records” in “maintenance records” is an item used to retrieve information relating to a motion guiding device 3 that needs to be subjected to maintenance. The item “unprocessed records” is an item used to retrieve, from among “all records”, information relating to a motion guiding device 3 which has not been subjected to maintenance yet. The item “processed records” is an item used to retrieve, from among “all records”, information relating to a motion guiding device 3 having been subjected to maintenance. The information relating to maintenance and/or the like may be configured to be stored in the server device 10 and to be retrieved therefrom by a user via the terminal device 16.

Each of the item “reviewing of diagnosis” and the item “analysis of graph” is an item used to display, for the designated motion guiding device 3, a graph of the degree of damage or the degree of lubrication, an analysis result, and/or the like.

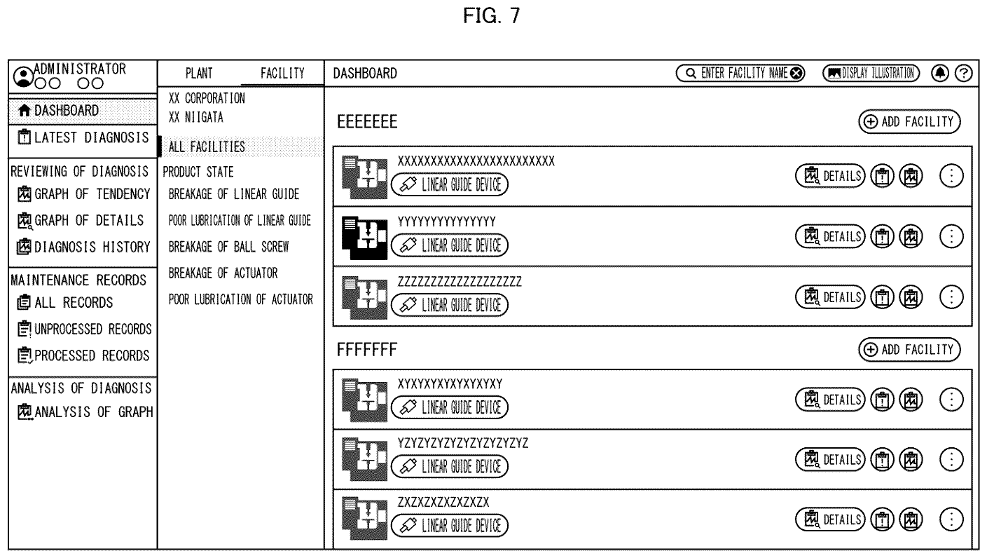

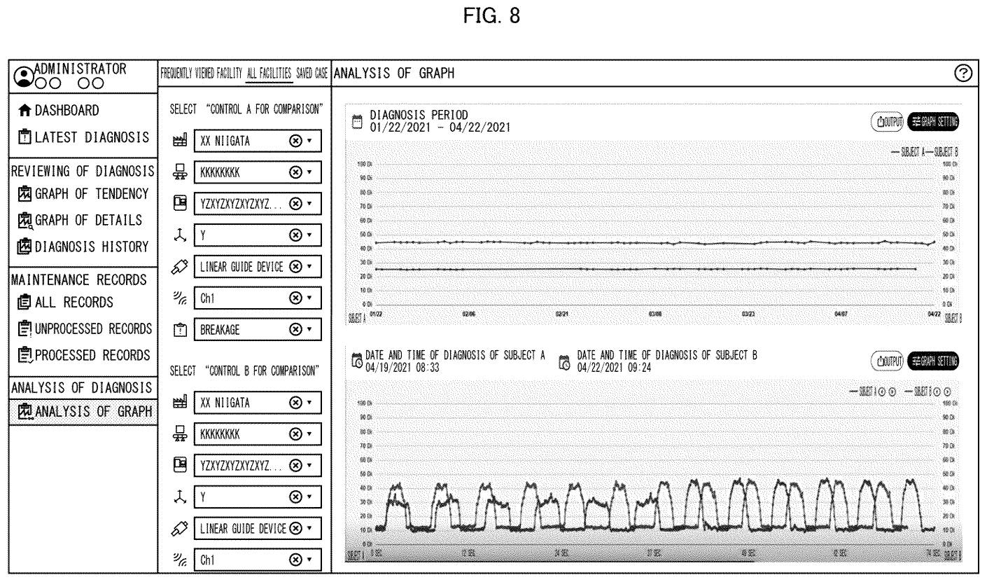

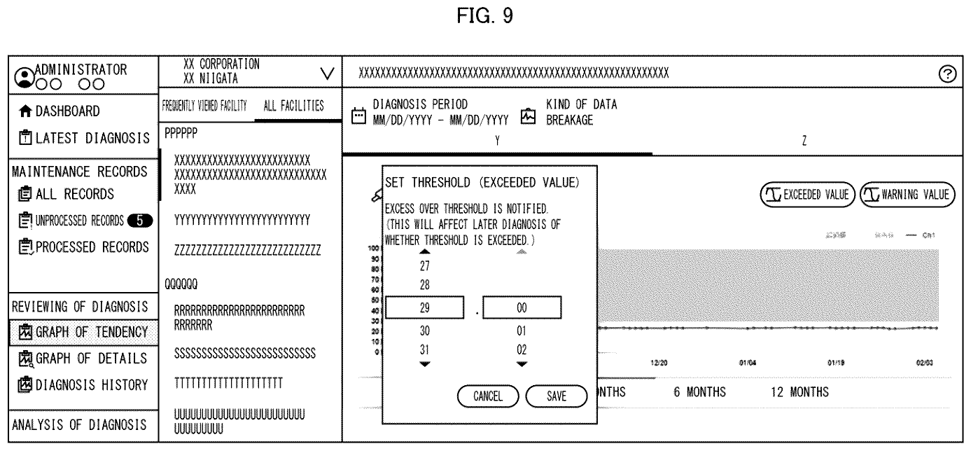

In FIG. 7, any of the items in “product state” can be selected so that information for a respective defective portion in the motion guiding device 3 is displayed. FIG. 8 shows an example in which the above-mentioned “analysis of graph” is selected to designate a plurality of motion guiding devices 3 and graphs indicative of the degrees of damage are displayed for comparison. FIG. 9 shows an example of a screen for setting a reference value used to make the determination in S104 in FIG. 5.

### Software Implementation Example

The functions of the server device 10 (hereinafter, referred to as a “device”) can be realized by a program for causing a computer to function as the device, the program causing the computer to function as the control blocks of the device.

In this case, the device includes a computer including at least one control device (e.g., a processor) and at least one storage device (e.g., a memory) as hardware for executing the program. By executing the program with use of the control device and the storage device, it is possible to realize the functions described in the foregoing embodiments.

The program may be stored in one or more non-transitory, computer-readable storage media. The one or more storage media may or may not be included in the device. In the latter case, the program can be supplied to the device via any wired or wireless transmission medium.

Some of or all of the functions of the control blocks can be realized by a logic circuit. For example, an integrated circuit in which a logic circuit that functions as the control blocks is formed is also encompassed in the scope of the present invention. In addition, the functions of the control blocks can be realized by, for example, a quantum computer.

Further, each of the processes described in the foregoing embodiments can be executed by artificial intelligence (AI). In this case, the AI may be operated by the control device or may be operated by another device (for example, an edge computer or a cloud server).

The present invention is not limited to the embodiments, but can be altered by a skilled person in the art within the scope of the claims. The present invention also encompasses, in its technical scope, any embodiment derived by combining technical means disclosed in differing embodiments.

### Cross-Reference of Related Applications

This application claims priority on Japanese Patent Application, Tokugan, No. 2021-185056 filed in Japan on Nov. 12, 2021, the entire contents of which are hereby incorporated by reference.

### Reference Signs List

1: monitoring system
3: motion guiding device
3a: linear guide device
3b: ball screw device
5, 5a, 5b: sensor
7: amplifier
10: server device
12: control section
13: storage section
14: learning section
16: terminal device
18: display section

1-6. (canceled)

7. A monitoring system that monitors a degree of at least one of damage and lubrication in a given movable part of each of one or more motion guiding devices, the movable part carrying out a reciprocating motion along a trajectory of the each of the one or more motion guiding devices, the monitoring system comprising:
a storage section that accumulates therein information corresponding to sensing results for a plurality of times of sensing carried out by a sensor provided to the each of the one or more motion guiding devices; and
a control section that generates and outputs a first screen in response to first input from a user, the first screen including information indicating changes in the degree observed in a certain period, the degree corresponding to the accumulated sensing results with respect to one of the one or more motion guiding devices which is designated by input from the user,
each of the sensing results which is for a single time of sensing being a sensing result corresponding to a plurality of times of reciprocating motions of the movable part,
the control section generating and outputting a second screen in response to second input from the user, the second screen including an analysis result for the one of the one or more motion guiding devices, the analysis result relating to changes in the degree observed in a certain period, and
the control section individually accepting the first input and the second input.

8. The monitoring system according to claim 7, wherein:
the control section outputs information indicating, in a comparative manner, degrees of at least one of damage and lubrication in the movable part which degrees correspond to sensing results with respect to, among the one or more motion guiding devices, two or more motion guiding devices designated by input from the user.

9. The monitoring system according to claim 7, wherein:
a first device associated with the sensor supplies information indicating a feature extracted from the sensing result to the storage section as information corresponding to the sensing result; and
the information indicating the feature is smaller in information amount than the information corresponding to the sensing result.

10. The monitoring system according to claim 7, wherein:
the control section generates and outputs a third screen in response to third input from the user, the third screen including (i) information relating to one of the one or more motion guiding devices which requires maintenance or (ii) information relating to one of the one or more motion guiding devices which has been subjected to maintenance; and
the control section individually accepts the first input, the second input, and the third input.

11. The monitoring system according to claim 7, wherein:
the storage section is included in a server device on a cloud; and
in response to designation of at least one of the one or more motion guiding devices, the control section obtains, from the server device, information corresponding to the sensing result with respect to the designated one of the one or more motion guiding devices.

12. The monitoring system according to claim 7, wherein:
the control section predicts, with reference to the information corresponding to the sensing result, time when the degree of at least one of damage and lubrication in the movable part reaches a predetermined degree.

13. The monitoring system according to claim 12, further comprising:
a learning section that trains a learning model with use of training data, the learning model receiving input of the information corresponding to the sensing result and outputting the predicted time when the degree of at least one of damage and lubrication in the movable part reaches the predetermined degree, the training data being a set of information corresponding to a sensing result obtained by the sensor and time when a degree of at least one of damage and lubrication in the movable part has reached the predetermined degree.

14. The monitoring system according to claim 7, wherein:
in a case where a value indicating information corresponding to a sensing result in at least one of the one or more motion guiding devices satisfies a predetermined condition, the control section notifies information indicating that the predetermined condition is satisfied.

15. The monitoring system according to claim 7, wherein:
the information corresponding to the sensing results for the plurality of times of sensing carried out by the sensor is automatically and continuously accumulated in the storage section after the monitoring system is activated.
